(19) United States
(12) Patent Application Publication
(10) Pub. No.: US 2022/0333429 A1
(43) Pub. Date: Oct. 20, 2022

(54) SENSOR ASSEMBLY FOR A LIFTGATE OPENING SYSTEM OF A REAR LIFTGATE OF A MOTOR VEHICLE

(71) Applicant: DUS Operating Inc., Auburn Hills, MI (US)

(72) Inventors: Lionel Bitauld, Gif Sur Yvette (FR); Joseph Bosnjak, Jouars Pontchartrin (FR); Francis Delavigne, Ollainville (FR); Indraneel Page, Farmington Hills, MI (US); Bhanumurthy Veeragandham, Rochester Mills, MI (US)

(21) Appl. No.: 17/231,373

(22) Filed: Apr. 15, 2021

(51) Int. Cl. E05F 15/74; E05F 15/75; E05B 83/18; E05B 81/78; E05B 81/76

(52) U.S. Cl. CPC E05F 15/74; E05F 15/75; E05B 83/18; E05B 81/78; E05B 81/77; E05Y 2400/822; E05Y 2400/86; E05Y 2600/46; E05Y 2900/546; E05Y 2800/426

(57) ABSTRACT

A sensor assembly for a liftgate opening system for a rear liftgate of a motor vehicle is provided. The rear liftgate includes a door frame, a stationary window, a lock device, and an actuator for moving the lock device between locked and unlocked states. The sensor assembly includes a housing attached to the stationary window and a substrate disposed within the housing. The sensor assembly further includes a capacitive touch sensor engaging a target portion of the stationary window and configured to generate a touch signal, in response to a user touching the target portion of the stationary window. The sensor assembly further includes a proximity sensor generating a proximity signal, in response to the user being disposed within a predetermined distance of the proximity sensor.

### FIELD

The present disclosure relates to door opening systems for motor vehicles, and more particularly, to a sensor assembly for a liftgate opening system of a rear liftgate of a motor vehicle.

### BACKGROUND

Modern vehicles with a rear liftgate can include a power liftgate system which automatically opens and closes the rear liftgate of a vehicle. The power liftgate system can use multiple kinds of remote keyless entry (RKE) software to automatically open and close rear liftgates and also automatically lock the rear liftgate. Car manufacturers have been developing hands-free power liftgate systems, which open the rear liftgate when, for example, the user may be carrying packages in both hands. The system can include a separate capacitive sensor, which is mounted to a door frame of the liftgate and spaced from a window of the liftgate. The location of these sensors may not be clearly marked, and their location may be unknown to users, who are unfamiliar with the vehicle. The system can further include a sensor-dedicated electronic control unit (ECU), which is configured to control the capacitive sensor and recognize whether the user wants to open the liftgate. However, these systems may have a high configuration cost and degradation of sensing performance. Furthermore, certain systems can include kick-sensor actuation, which requires the user to lift one foot to access a sensor located at a bottom end inside of a rear bumper. This action requires the user to balance on one foot to maintain stability. In addition, the liftgate may have a large rotational trajectory, such that the user may need to maneuver out of the path of the liftgate while or immediately after balancing on one foot to activate the sensor.

Accordingly, there is a need for a liftgate opening system that allows users, who are unfamiliar with the vehicle, to identify the location of the sensor to open the liftgate without requiring the user to balance on one foot and/or maneuver out of the path of the liftgate.

### SUMMARY

According to several aspects, a sensor assembly is provided for a liftgate opening system of a rear liftgate for a motor vehicle. The rear liftgate includes a door frame, a stationary window held in a fixed position relative to the door frame, a lock device movable between a locked state and an unlocked state, and an actuator for moving the lock device between the locked and unlocked states. The sensor assembly includes a housing adapted to be attached to the stationary window and a substrate disposed within the housing. The sensor assembly further includes a capacitive touch sensor attached to the substrate and adapted to be directed to a target portion of the stationary window. The capacitive touch sensor is configured to generate a touch signal, in response to a user touching the target portion of the stationary window. The sensor assembly further includes a proximity sensor attached to the substrate. The proximity sensor is configured to generate a proximity signal, in response to the user being disposed within a predetermined distance of the proximity sensor.

In one aspect, the proximity sensor includes a capacitive proximity sensor, an inductive proximity sensor, or a photoelectric sensor.

In another aspect, the substrate includes a flexible film or a rigid PCB adapted to be directed to the target portion of the stationary window.

In another aspect, the substrate includes at least one of a user prompt and a logo.

In another aspect, the substrate includes a serigraphy adapted to be directed to the stationary window.

In another aspect, the sensor assembly further includes one or more light sources attached to the substrate and configured to emit a light through the stationary window, in response to at least one of: the user touching the target portion of the stationary window; the user being disposed within the predetermined distance of the proximity sensor; the processor generating the key fob query signal; and the processor determining that the key fob is an authorized device.

In another aspect, the sensor assembly further includes a light guide disposed adjacent to at least one of the light source and the stationary window. The light guide is configured to direct light through at least one of the user prompt, the logo, and the stationary window.

According to several aspects, a motor vehicle includes a front end, a rear end disposed distal to the front end, and a rear liftgate having a door frame pivotably attached to the rear end and movable between open and closed positions. The rear liftgate further includes a stationary window held in a fixed position relative to the door frame. The rear liftgate further includes a lock device movable between a locked state for holding the door frame in the closed position and an unlocked state where the door frame is movable to the open position. The rear liftgate further includes an actuator for moving the lock device between the locked and unlocked states. The rear liftgate further includes a motor for moving the rear liftgate to at least one of the open and closed positions. The rear liftgate further includes a liftgate opening system having a sensor assembly that includes a housing attached to the stationary window and a substrate disposed within the housing. The sensor assembly further includes a capacitive touch sensor, which is attached to the substrate and directed to a target portion of the stationary window. The capacitive touch sensor is configured to generate a touch signal, in response to a user touching the target portion of the stationary window. The sensor assembly further includes a proximity sensor attached to the substrate. The proximity sensor is configured to generate a proximity signal, in response to the user being disposed within a predetermined distance of the proximity sensor. The system further includes a processor for generating a key fob query signal, in response to the processor receiving at least one of the touch signal from the capacitive touch sensor and the proximity signal from the proximity sensor. The system further includes a key fob generating a reply signal, in response to the key fob receiving the key fob query signal from the processor. The processor generates an unlock signal and an open signal, in response to the processor determining that the key fob is an authorized device based on the reply signal. The actuator moves the lock device to the unlocked state, in response to the actuator receiving the unlock signal from the processor. The motor moves the door frame to the open position, in response to the motor receiving the open signal from the processor.

In one aspect, the proximity sensor includes at least one of a capacitive proximity sensor, an inductive proximity sensor, and a photoelectric sensor.

In another aspect, the substrate is a flexible film or a rigid PCB engaging the target portion of the stationary window.

In another aspect, the substrate includes at least one of a user prompt and a logo.

In another aspect, the substrate includes a serigraphy engaging the stationary window.

In another aspect, the sensor assembly further includes one or more light sources attached to the substrate. The light sources are configured to emit a light through the stationary window, in response to at least one of: the user touching the target portion of the stationary window; the user being disposed within the predetermined distance of the proximity sensor; the processor generating the key fob query signal; and the processor determining that the key fob is an authorized device.

In another aspect, the sensor assembly further includes a light guide disposed adjacent to at least one of the light source and the stationary window. The light guide is configured to direct light from the light source through at least one of the user prompt, the logo, and the stationary window.

According to several aspects, a method of operating a liftgate opening system for a rear liftgate of a motor vehicle is provided. The rear liftgate includes a door frame and a stationary window held in a fixed position relative to the door frame. The system includes a housing attached to the stationary window and a substrate disposed within the housing. The system further includes a capacitive touch sensor engaging a target portion of the stationary window, a proximity sensor, a processor, and a key fob. The method includes the capacitive touch sensor generating a touch signal, in response to a user touching a target portion of the stationary window. The proximity sensor generates a proximity signal, in response to the user being disposed within a predetermined distance of the proximity sensor. The processor generates a key fob query signal, in response to the processor receiving at least one of the touch signal from the capacitive touch sensor and the proximity signal from the proximity sensor. The key fob generates a reply signal, in response to the key fob receiving the key fob query signal from the processor. The processor generates an unlock signal, in response to the processor determining that the key fob is an authorized device based on the reply signal. The actuator moves the lock device to the unlocked state, in response to the actuator receiving the unlock signal from the processor.

In one aspect, a capacitive proximity sensor, an inductive proximity sensor, or a photoelectric sensor generates the proximity signal, in response to the user being disposed within a predetermined distance of the proximity sensor.

In another aspect, one or more light sources emit a light through the stationary window, in response to at least one of: the user touching the target portion of the stationary window; the user being disposed within the predetermined distance of the proximity sensor; the processor generating the key fob query signal; and the processor determining that the key fob is an authorized device.

In another aspect, a light guide directs light from one or more of the light sources through at least one of the stationary window and a logo attached to the stationary window.

In another aspect, the processor generates an open signal, in response to the processor determining that the key fob is the authorized device based on the reply signal. A motor moves the door frame to an open position, in response to the motor receiving the unlock signal from the processor.

In another aspect, the substrate is provided in a configuration of a user prompt, with the capacitive touch sensor and the proximity sensor adjacent to the user prompt. The user prompt is displayed through the stationary window.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a perspective view of one example of a motor vehicle having a rear liftgate with a liftgate opening system, illustrating the rear liftgate disposed in a closed position.

FIG. 2 is a perspective view of one example of a motor vehicle having a rear liftgate with a liftgate opening system, illustrating the rear liftgate disposed in an open position.

FIG. 3 is a block diagram of the liftgate opening system of FIG. 1.

FIG. 4 is an enlarged rear end view of the rear liftgate of FIG. 1, illustrating the system including a user prompt or instruction that is visible through the window.

FIG. 5 is a cross-sectional view of a portion of the rear liftgate of FIG. 4 as taken along line 5-5, illustrating the liftgate opening system attached to a stationary window.

FIG. 6 is an enlarged rear end view of another example of the rear liftgate of FIG. 1.

FIG. 7 is a flow chart of one example of a method of operating the liftgate opening system of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

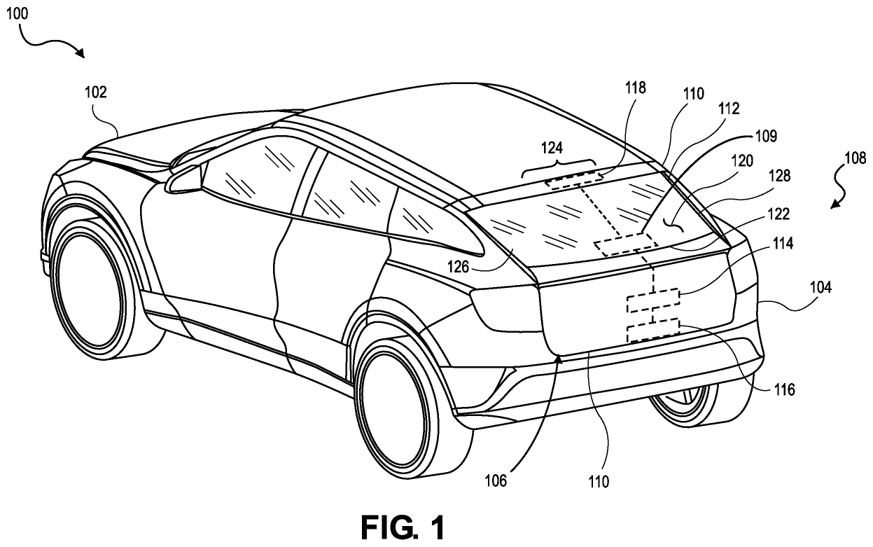

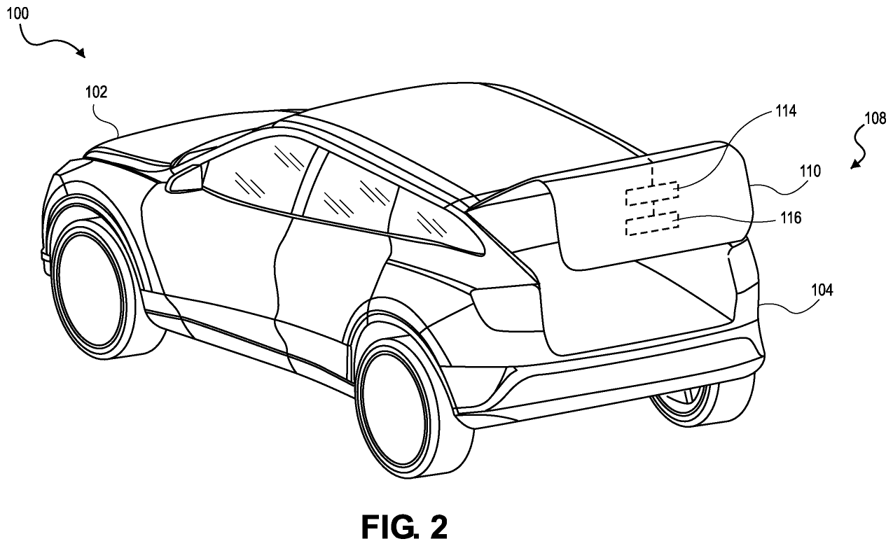

Referring to FIGS. 1 and 2, one example of a motor vehicle 100 has a front end 102, a rear end 104 disposed distal to the front end 102, and a rear liftgate 106 with a liftgate opening system 108 having a sensor assembly 109. The rear liftgate 106 includes a door frame 110 pivotably attached to the rear end 104 and movable between an open position (FIG. 1) and a closed position (FIG. 2). The rear liftgate 106 further includes a stationary window 112 held in a fixed position relative to the door frame 110.

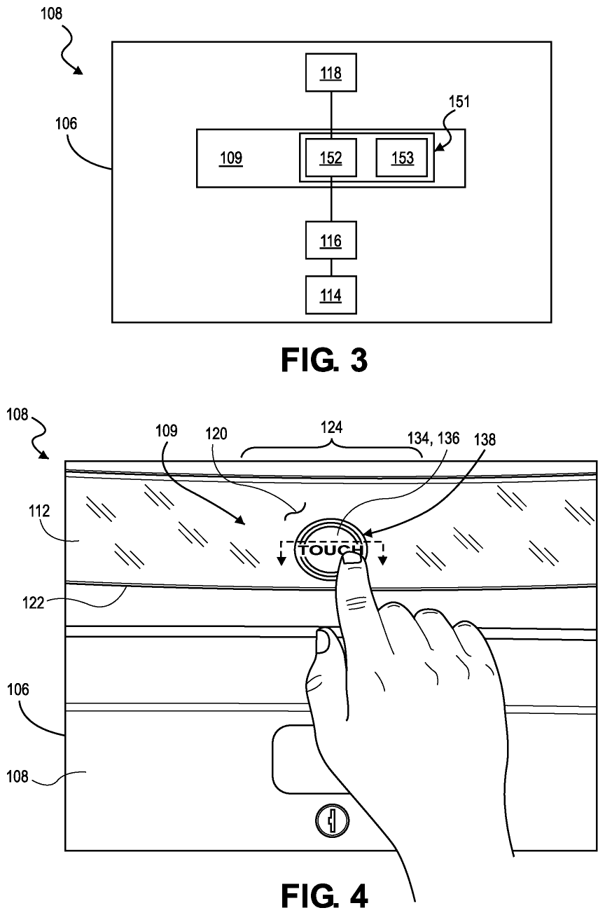

Referring to FIG. 3, the rear liftgate 106 further includes a lock device 114 that is movable between a locked state for holding the door frame 110 (FIG. 1) in the closed position and an unlocked state where the door frame 110 is movable to the open position. The rear liftgate 106 further includes an actuator 116 for moving the lock device between the locked and unlocked states. The rear liftgate 106 further includes a motor 118 for moving the rear liftgate 106 to at least one of the closed and open positions. The rear liftgate 106 further includes the liftgate opening system 108 (system) that is coupled to at least one of the actuator 116 for operating the lock device 114 and the motor 118 for moving the rear liftgate 106 to at least one of the open and closed positions.

Referring to FIG. 4, the sensor assembly 109 is attached to a target portion 120 of the stationary window 112. The window 112 includes a bottom edge 122 relative to a vertical direction when the rear liftgate is disposed in the closed position and a middle section 124 disposed between left and right sides 126, 128 (FIG. 1) of the window 112. In this non-limiting example, the target portion 120 is a portion of the middle section 124 that is adjacent to the bottom edge 122 of the window 112. However, in other examples, the sensor assembly 109 can be attached to other suitable portions of the window.

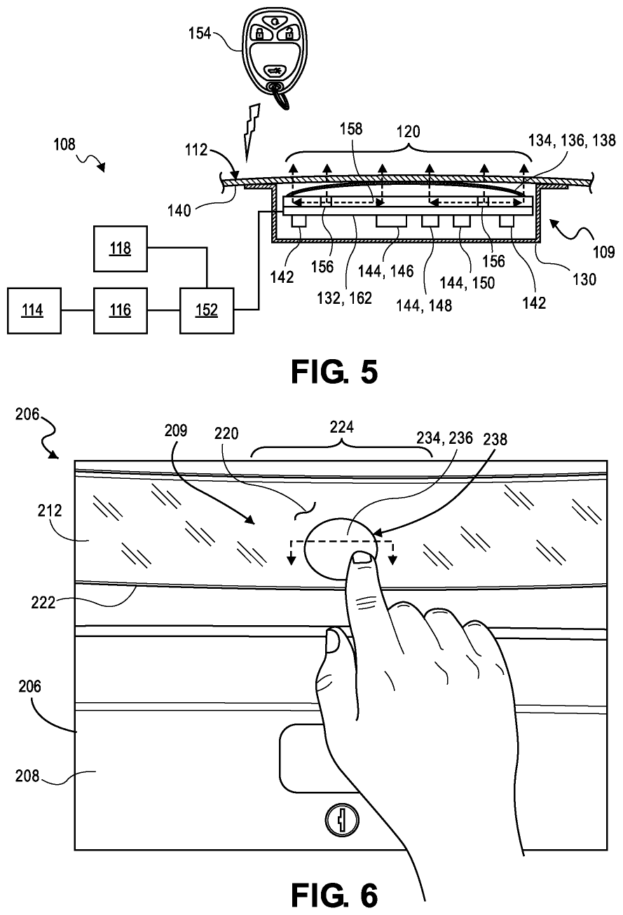

Referring now to FIG. 5, sensor assembly 109 includes a housing 130 attached to the target portion 120 of the stationary window 112 and a substrate 132 disposed within the housing 130. In this non-limiting example, the substrate 132 can include a rigid Printed Circuit Board (PCB) 162 proximal to the target portion 120 of the stationary window 112 with a flexible film 134 engaged or directed to the target portion 120 of the window 112.

Referring back to FIG. 4, the flexible film 134 includes a user prompt 136 formed from a serigraph 138 that engages an interior surface 140 (FIG. 5) of the window 112 and is visible through the window 112 to the external environment of the vehicle 100. The serigraph 138 can be a print applied to the flexible film 134 a silkscreen process, and the serigraph 138 can represent the prompt or instruction, such as “Touch,” for a user operating sensor assembly 109. However, it is contemplated that the user prompt 136 can be formed on the flexible film by other suitable processes. As described in more detail below, the substrate can be made of other suitable materials and include other prompts, instructions, logos, graphics, or marks visible through the window 112.

Referring again to FIG. 5, sensor assembly 109 further includes one or more capacitive touch sensors 142, which are attached to the substrate 132 and directed to the target portion 120 of the stationary window 112. Each capacitive touch sensor 142 is a short-range capacitive sensor configured to generate a touch signal, in response to the sensor 142 detecting a change in the electric field when the user is located within fifteen (15) centimeters of capacitive touch sensor 142. In another example, the capacitive touch sensor 142 is a short-range capacitive sensor configured to generate the touch signal, in response to the user only touching the target portion 120 of the stationary window 112.

The sensor assembly 109 further includes one or more proximity sensors 144 attached to the substrate 132. The proximity sensor 144 can be a long-range capacitive sensor configured to generate a proximity signal, in response to the user changing the electric field when the user is located within a predetermined distance of the proximity sensor 144, e.g. in the range between fifteen (15) centimeters and fifty (50) centimeters. It is contemplated that the long-range capacitive sensor can be configured to generate the proximity signal, in response to the user being within other suitable distances from the sensor, e.g. more than 50 centimeters from the sensor. The proximity sensors 144 can include a capacitive proximity sensor 146, an inductive proximity sensor 148, a photoelectric sensor 150, other suitable proximity sensors, or any combination of the same.

The system 108 further includes a processor 152 for generating a key fob query signal, in response to the processor 152 receiving at least one of the touch signal from the capacitive touch sensor 142 and the proximity signal from the proximity sensor 144 of the sensor assembly 109. The system 108 further includes a key fob 154 generating a reply signal, in response to the key fob 154 receiving the key fob query signal from the processor 152. The processor 152 generates an unlock signal and an open signal, in response to the processor 152 determining that the key fob 154 is an authorized device based on the reply signal. The actuator 116 moves the lock device 114 to the unlocked state, in response to the actuator 116 receiving the unlock signal from the processor 152, and the motor 118 moves the door frame 110 to the open position, in response to the motor 118 receiving the open signal from the processor 152. In this example, the processor 152 is an ECU of a Passive Entry Passive Start module (PEPS module), and the PEPS module and the associated key fob hardware and software are native components of the motor vehicle adapted to communicate with the system 108 via a CAN interface. In other examples, the processor, the key fob, the sensor assembly, and other aforementioned components can be dedicated parts of a system that is independent from the PEPS module or other native system of the vehicle.

The system 108 further includes one or more light sources 156 attached to the substrate 132 and configured to emit a light through the stationary window 112, in response to at least one of: the user touching the target portion 120 of the stationary window 112; the user being disposed within the predetermined distance of the proximity sensor 144; the processor 152 generating the key fob query signal; and the processor 152 determining that the key fob 154 is an authorized device. The system 108 further includes a light guide 158 disposed adjacent to at least one of the light source 156 and the stationary window 112, with the light guide 158 being configured to direct light through at least one of the user prompt 136 (FIG. 4) and the stationary window 112. For instance, the light sources 156 may emit light through the user prompt, in response to the processor 152 receiving the proximity signal from the proximity sensor 144.

Referring to FIG. 6, another example of a liftgate opening system 208 is similar to the liftgate opening system 108 of FIG. 4 and includes the same components identified by the same numbers increased by 100. However, while the system 108 of FIG. 4 includes the user prompt 136, the system 108 includes a logo 260. In this example, the logo 260 can be a symbol associated with the make, model, or trim of the vehicle. In other examples, the symbol can be any shape, e.g. a circle, oval, square, triangle, or an icon for an open liftgate, etc., through which the light source 256 and/or light guide 258 emit light when the user operates the system 208.

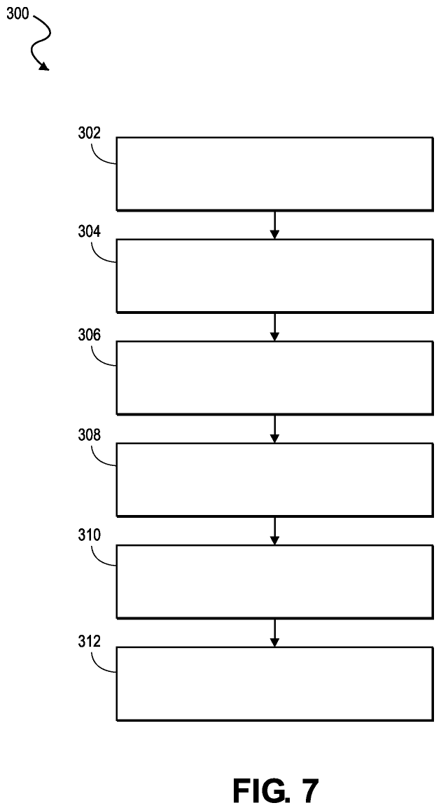

Referring now to FIG. 7, a flow chart of one exemplary method 300 for operating the system 108 of FIG. 1 is illustrated. The method 300 commences at block 302 with the user prompt 136 being displayed through the stationary window 112. The capacitive touch sensor 142 generates the touch signal, in response to a user touching the target portion 120 of the stationary window. The proximity sensor 144 generates the proximity signal, in response to the user being disposed within a predetermined distance of the proximity sensor 144. This step can be accomplished by at least one of the capacitive proximity sensor 146, the inductive proximity sensor 148, and the photoelectric sensor 150 generating the proximity signal, in response to the user being disposed within a predetermined distance of the proximity sensor 144. One or more of the light sources 156 can emit light through the light guide 158, which in turn directs light through the user prompt 136 and the stationary window 112, in response to at least one of: the user touching the target portion 120 of the stationary window 112; the user being disposed within the predetermined distance of the proximity sensor 144; the processor 152 generating the key fob query signal (as described below); and the processor 152 determining that the key fob 154 is an authorized device (as described below). In one example, the light sources 156 can emit light through the user prompt 136 and the stationary window 112, in response to the processor 152 receiving the proximity signal from the proximity sensor 144.

At block 304, the processor generates the key fob query signal, in response to the processor 152 receiving the touch signal from the capacitive touch sensor 142 or the proximity signal from the proximity sensor 144.

At block 306, the key fob 154 generates the reply signal, in response to the processor 152 receiving the key fob query signal from the processor 152.

At block 308, the processor 152 generates the unlock signal and the open signal, in response to the processor 152 determining that the key fob 154 is an authorized device based on the reply signal from the processor 152.

At block 310, the actuator 116 moves the lock device 114 to the unlocked state, in response to the actuator 116 receiving the unlock signal from the processor 152.

At block 312, the motor 118 moves the door frame 110 to the open position, in response to the motor 118 receiving the unlock signal from the processor 152.

The system 108 includes a computer 151 having the processor 152 and memory 153. Computers and computing devices generally include computer executable instructions, where the instructions may be executable by one or more computing devices such as those listed above. Computer executable instructions may be compiled or interpreted from computer programs created using a variety of programming languages and/or technologies. Some of these applications may be compiled and executed on a virtual machine. In general, the processor 152 (e.g., a microprocessor) receives instructions, e.g., from a memory 153, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory 153 may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A sensor assembly for a liftgate opening system for a rear liftgate of a motor vehicle, with the rear liftgate including a door frame, a stationary window held in a fixed position relative to the door frame, the liftgate opening system comprising:
a housing adapted to be attached to the stationary window;
a substrate disposed within the housing;
a capacitive touch sensor attached to the substrate and adapted to be directed to a target portion of the stationary window, with the capacitive touch sensor configured to generate a touch signal in response to a user touching the target portion of the stationary window; and
a proximity sensor attached to the substrate and configured to generate a proximity signal in response to the user being disposed within a predetermined distance of the proximity sensor.

2. The sensor assembly of claim 1 wherein the proximity sensor comprises at least one of a capacitive proximity sensor, an inductive proximity sensor, and a photoelectric sensor.

3. The sensor assembly of claim 2 wherein the substrate comprises one of a flexible film and a rigid PCB adapted to be directed to the target portion of the stationary window.

4. The sensor assembly of claim 3 wherein the substrate comprises at least one of a user prompt and a logo.

5. The sensor assembly of claim 3 wherein the substrate comprises a serigraphy adapted to be directed to the stationary window.

6. The sensor assembly of claim 3 further comprising at least one light source attached to the substrate and configured to emit a light through the stationary window in response to at least one of:
the user touching the target portion of the stationary window;
the user being disposed within the predetermined distance of the proximity sensor;
the processor generating the key fob query signal; and
the processor determining that the key fob is an authorized device.

7. The sensor assembly of claim 6 further comprising a light guide disposed adjacent to at least one of the light source and the stationary window, with the light guide being configured to direct light through at least one of the logo and the stationary window.

8. A motor vehicle comprising:
a front end;
a rear end disposed distal to the front end;
a rear liftgate comprising:
a door frame pivotably attached to the rear end and movable between an open position and a closed position;
a stationary window held in a fixed position relative to the door frame;
a lock device movable between a locked state for holding the door frame in the closed position and an unlocked state where the door frame is movable to the open position; and
an actuator for moving the lock device between the locked and unlocked states;
a motor for moving the rear liftgate to at least one of the open and closed positions;
a liftgate opening system comprising:
a sensor assembly comprising:
a housing attached to the stationary window;
a substrate disposed within the housing;
a capacitive touch sensor attached to the substrate and directed to a target portion of the stationary window, with the capacitive touch sensor configured to generate a touch signal in response to a user touching the target portion of the stationary window; and
a proximity sensor attached to the substrate and configured to generate a proximity signal in response to the user being disposed within a predetermined distance of the proximity sensor;
a processor for generating a key fob query signal in response to the processor receiving at least one of the touch signal from the capacitive touch sensor and the proximity signal from the proximity sensor; and
a key fob generating a reply signal in response to the key fob receiving the key fob query signal from the processor;
wherein the processor generates an unlock signal and an open signal in response to the processor determining that the key fob is an authorized device based on the reply signal;
wherein the actuator moves the lock device to the unlocked state in response to the actuator receiving the unlock signal from the processor; and
wherein the motor moves the door frame to the open position in response to the motor receiving the open signal from the processor.

9. The motor vehicle of claim 8 wherein the proximity sensor comprises at least one of a capacitive proximity sensor, an inductive proximity sensor, and a photoelectric sensor.

10. The motor vehicle of claim 9 wherein the substrate comprises one of a flexible film and a rigid PCB engaging the target portion of the stationary window.

11. The motor vehicle of claim 10 wherein the substrate comprises at least one of a user prompt and a logo.

12. The motor vehicle of claim 10 wherein the substrate comprises a serigraphy engaging the stationary window.

13. The motor vehicle of claim 10 wherein the sensor assembly further comprises at least one light source attached to the substrate and configured to emit a light through the stationary window in response to at least one of:
the user touching the target portion of the stationary window;
the user being disposed within the predetermined distance of the proximity sensor;
the processor generating the key fob query signal; and
the processor determining that the key fob is an authorized device.

14. The motor vehicle of claim 13 wherein the sensor assembly further comprises a light guide disposed adjacent to at least one of the light source and the stationary window, with the light guide configured to direct light from the at least one light source through at least one of the logo and the stationary window.

15. A method of operating a liftgate opening system for a rear liftgate of a motor vehicle, the rear liftgate including a door frame and a stationary window held in a fixed position relative to the door frame, the liftgate opening system having a sensor assembly that includes a housing attached to the stationary window, a substrate disposed within the housing, a capacitive touch sensor engaging a target portion of the stationary window, and a proximity sensor, with the liftgate opening system further including a processor and a key fob, the method comprising:
generating, using the capacitive touch sensor, a touch signal in response to a user touching a target portion of the stationary window;
generating, using the proximity sensor, a proximity signal in response to the user being disposed within a predetermined distance of the proximity sensor;
generating, using the processor, a key fob query signal in response to the processor receiving at least one of the touch signal from the capacitive touch sensor and the proximity signal from the proximity sensor;
generating, using the key fob, a reply signal in response to the key fob receiving the key fob query signal from the processor;
generating, using the processor, an unlock signal in response to the processor determining that the key fob is an authorized device based on the reply signal; and
moving, using the actuator, the lock device to the unlocked state in response to the actuator receiving the unlock signal from the processor.

16. The method of claim 15 further comprising generating, using at least one of a capacitive proximity sensor, an inductive proximity sensor, and a photoelectric sensor, the proximity signal in response to the user being disposed within a predetermined distance of the proximity sensor.

17. The method of claim 16 further comprising emitting, using at least one light source, a light through the stationary window in response to at least one of:
the user touching the target portion of the stationary window;
the user being disposed within the predetermined distance of the proximity sensor;
the processor generating the key fob query signal; and
the processor determining that the key fob is an authorized device.

18. The method of claim 17 further comprising directing light, using a light guide, from the at least one light source through at least one of the stationary window and a logo attached to the stationary window.

19. The method of claim 18 further comprising:
generating, using the processor, an open signal in response to the processor determining that the key fob is the authorized device based on the reply signal; and
moving, using a motor, the door frame to an open position in response to the motor receiving the unlock signal from the processor.

20. The method of claim 19 further comprising:
providing the substrate in a configuration of a user prompt, with the capacitive touch sensor and the proximity sensor adjacent to the user prompt; and
displaying the user prompt through the stationary window.
